(19) United States
(12) Patent Application Publication
(10) Pub. No.: US 2006/0077670 A1
(43) Pub. Date: Apr. 13, 2006

(54) Rechargeable compact fluorescent flood light

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/964,246

(22) Filed: Oct. 12, 2004

(51) Int. Cl. F21V 19/02

(52) U.S. Cl. 362/372

(57) ABSTRACT

The present invention is relates to a rechargeable compact fluorescent flood light and more particularly, to a rechargeable compact fluorescent flood light with a handle and two supporting legs. Said two supporting legs may move relatively and interactively between position one and position two. If both said supporting legs are adjusted to an angle over 90°, user may place said light on shoulder to provide long distance lighting. Said supporting legs can also provide an adjustable mean with a tight or loose positions so as to controlling such supporting legs in a locked position or in a rotating position to reach the best lighting range and lighting angles through said attached hinge to any position within 270 degrees circular ark. The present invention is an important source of light used in marine, army, public security, firefighting, emergency treatment, disciplined troop, architecture and civil vessels, as well as emergency treatment in daily life.

### BACKGROUND OF THE PRESENT INVENTION

1. Field of Invention

The present invention is relates to a rechargeable compact fluorescent flood light and more particularly, to a rechargeable compact fluorescent flood light with a handle and two supporting legs. Said two supporting legs may move relatively and interactively between position one and position two. If both said supporting legs are adjusted to an angle over 90°, user may place said light on shoulder to provide long distance lighting.

2. Description of Related Arts

Handheld compact fluorescent with focused beams, flood light, spotlights or searchlights, whether battery-powered or line-powered, are commonly used by military, law enforcement, fire and rescue personnel, security personnel, hunters and recreational boaters among others for nighttime surveillance in any application where a high intensity spotlight is required. The conditions of use are highly varied, but generally require the light to deliver a desired field of view at long distances, be reliable, durable and field maintainable in order for it to be practically used in the designed applications. Typically the light is hand carried and must be completely operable using simple and easily access manual controls, which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, the lighting range, lighting angles and the lighting power of a candle are minimal. Such lantern light up by a candle will not be the most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting legs. The mounting is a tripod mount so that the portable searchlight may be fixed in the field to a tripod with the second device. The mounting on the handle is a thumbscrew mount to permit mounting of an optical detection device onto the searchlight and rigidly fixed to the housing. However, this lantern provide without no ability to move any angle to obtain a better light range.

### SUMMARY OF THE PRESENT INVENTION

The main object of the present invention is to provide a rechargeable compact fluorescent having a supporting means and such supporting means can provide an ability to rotate an angle more than 90 degree so as to provide a platform for user to place said fluorescent on shoulder.

Another object of the present invention is to provide a rechargeable compact fluorescent having a supporting means and such supporting mean can provide an ability to rotate and/or to move any angles within 270 degree circular arc.

Another object of the present invention is to provide a rechargeable compact fluorescent having an ability to adopt difference power source supplies.

Another object of the present invention is to provide a rechargeable compact fluorescent having a supporting means and such supporting mean can provide an adjustable mean with a tight or loose positions so as to controlling such supporting legs in a locked position or in a rotating position to reach the best lighting range and lighting angles.

Accordingly, to achieve the above objects, a rechargeable compact fluorescent comprises:
a rectangular housing, inside of it contains a mean of lighting source;
a plurality of reflector is fixed around said mean of light source; and
a transparent front flat board;
a sealed packing collar is connecting a inner portion of said transparent front flat board and said reflector which resides inside of an annular nut. Said annular nut providing a fixed position and a disassembled position on front portion of said housing. Surface of said annular nut, which is located in front of said housing, set an annular shockproof nut. It is made of rubber or other soft material to prevent said rechargeable halogen lantern from shocks or quakes when excessive external force applied to it.

### BRIEF DESCRIPTION OF THE DRAWINGS

FIG. 1 is a left side view of the present invention.

FIG. 2 is a right side view thereof;

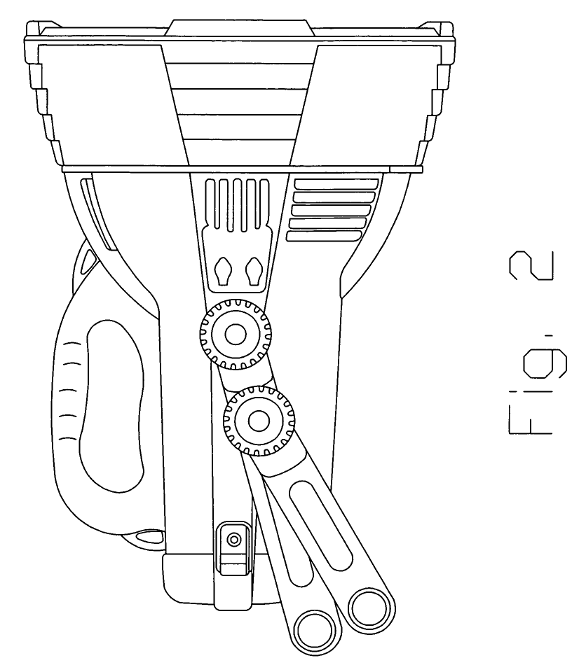

FIG. 3 is a front view thereof;

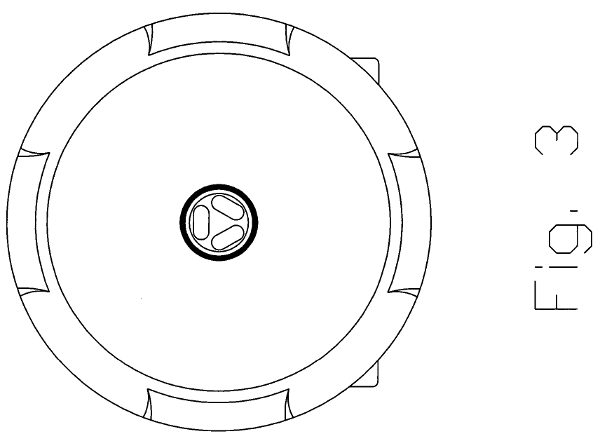

FIG. 4 is a rear view thereof;

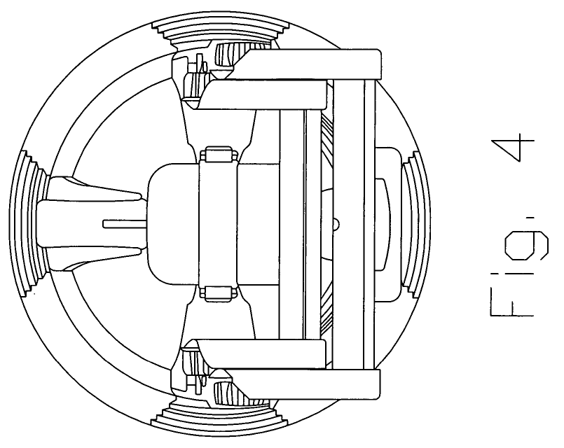

FIG. 5 is a top view thereof;

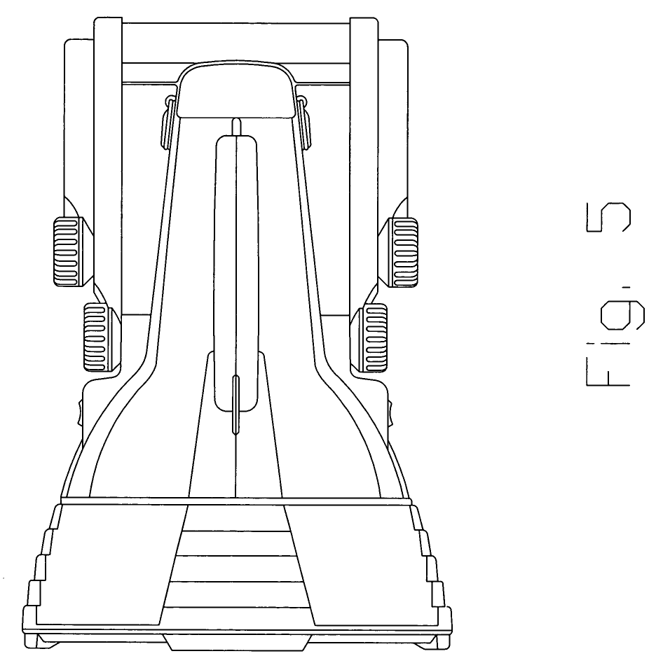

FIG. 6 is a rear view thereof;

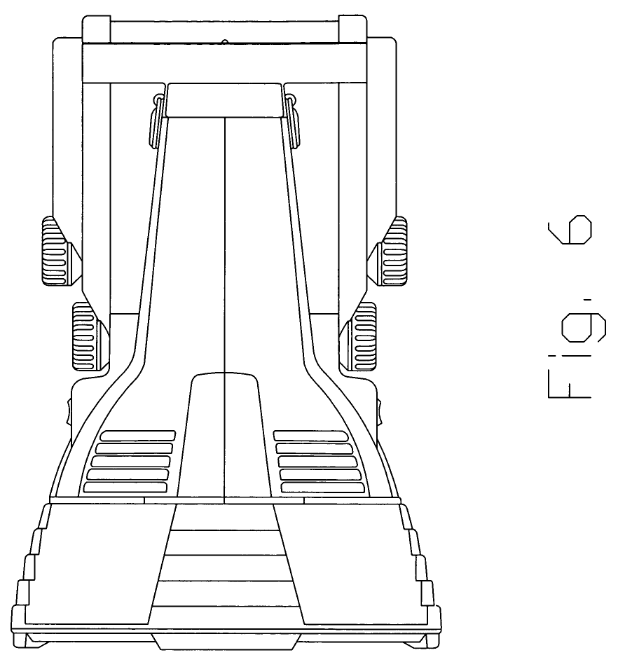

FIG. 7 is a perspective view thereof;

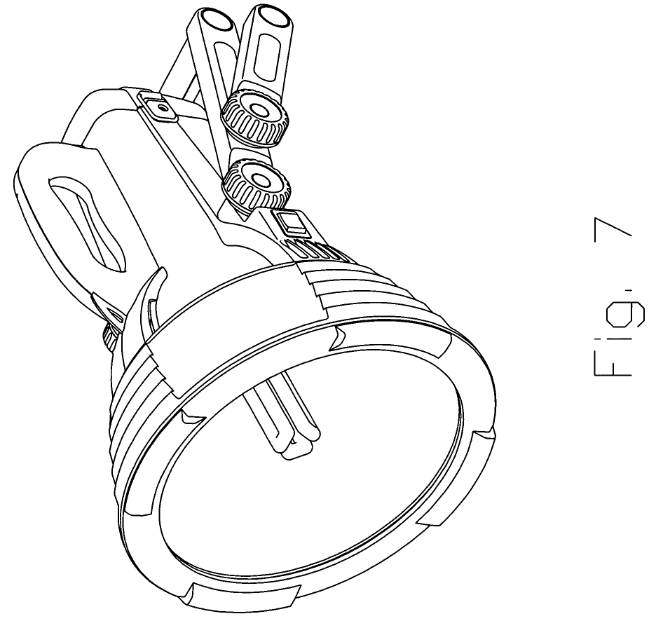

FIG. 8 is another perspective view thereof;

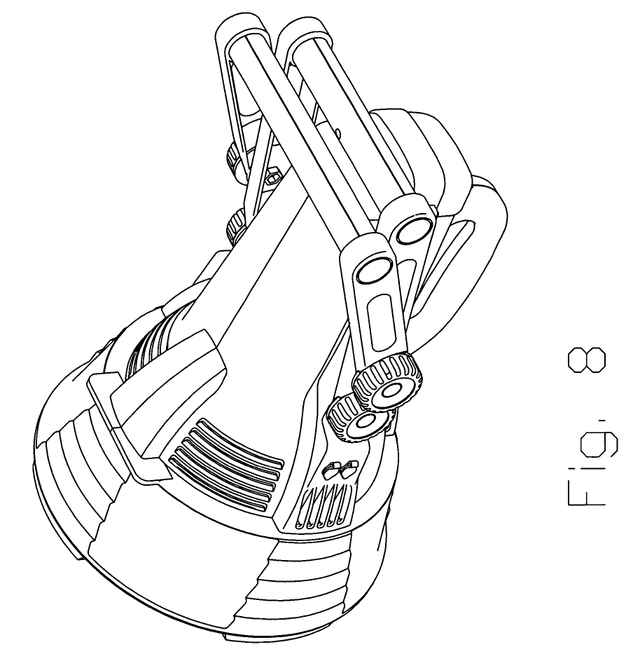

FIG. 9 is another perspective view thereof;

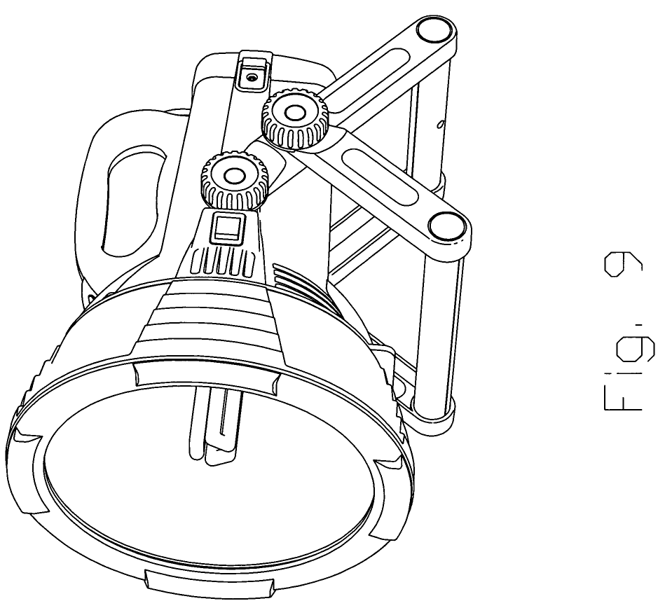

FIG. 10 is a structural view with numbered components thereof.

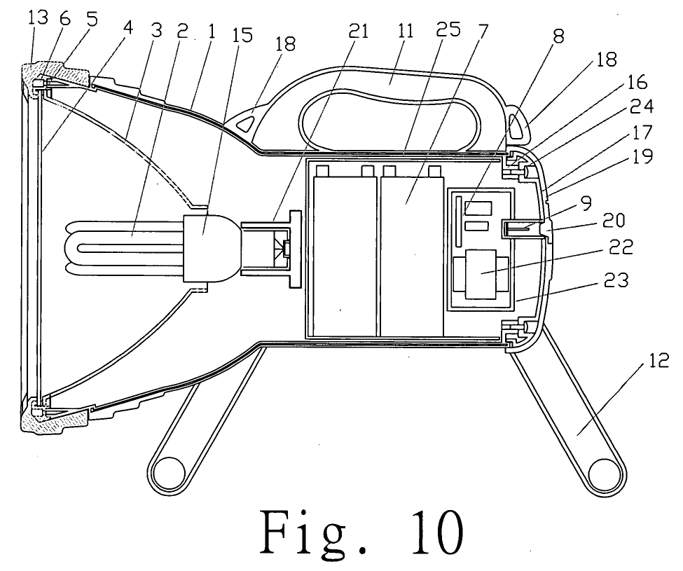

### DETAILED DESCRIPTION OF THE PREFERRED EMBODIMENT

Rechargeable Compact Fluorescent Flood Light comprises an illuminant (1) usually in a shape of a rectangular cylinder. Inside said illuminant (1), there is a light source (2), a reflector (3) generally in a shape of a parabola, and a front panel (4) usually made of glass or other transparent materials. By a sealing washer (5), said front panel (4) is sealed to end portion of said reflector (3) within a front annular head (6) from inside. Said annular head (6) may be fastened to a front end of said illuminant (1) in a dismantling manner. On the surface of said annular head (6) in front of said illuminant (1), there is an annular lightening protection head (13) made of rubber or flexible material that enables a photoelectric source searchlight to absorb the shock from outside.

As illustrated in figures, said light source (2) consists of an energy-saving fluorescent bulb (15), which can be fastened to a socket (21) and is powered by the built-in power source (7) of said illuminant. A power connects to a electric circuit device (8) inside said illuminant (1), a power transformer (22), a external socket (9), a switch (10) and said connected energy-saving light bulb (15) through a power line. It is obvious that a source of power may either be rechargeable battery or the municipal power supply. Said electric circuit device (8) and said power transformer (22) are installed inside a power component (23), so as to prevent users from touching it when dismantling a battery cover (17). Said socket (21) is fastened to a front surface of a power box (25).

A hand grip (11) is a rectangular cylinder structure that is fastened to said illuminant (1). Both front and rear end portions of said hand grip (11) have shoulder strip buttons (18) for convenience for user.

A stands (12) is flexibly attached to said illuminant (1), and may be tightened up with an adjustable latch (14) to fasten said stands. Said stands (12) may pivot around a hinge and remain at any position within the 2700 arc, so as to provide a support for said illuminant (1) on a plant surface to achieve a optimal lighting angle.

There is a flexibly connected battery cover (17) at a back portion of said illuminant (1). Said battery cover (17) is fastened to a flange (16) on back of portion of said illuminant (1) by a metal screw (24). By a sealing washer (21), at rear end of said illuminant (1), there is a sealed with a front surface of said battery cover (17) from inside. Said battery cover (17) is fastened to rear end portion of said illuminant (1) in a dismantling manner. After separating said battery cover (14) from said illuminant (1), user can replace batteries therein. There is a sealing head (19) made of resilient materials on top surface of said battery cover (17). Said sealing head (19) is attached to a shield (20), which seals all possible entrance to said external socket (9) to provide protection against damage and intrusion of rain or water.

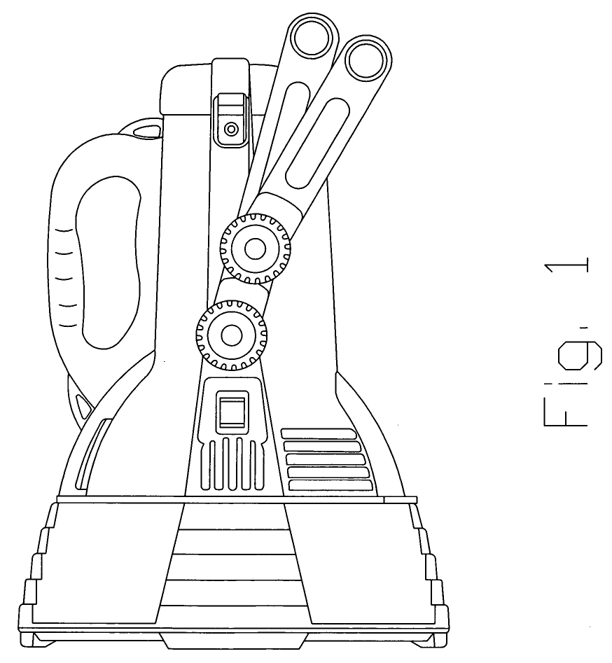

In another word, as shown in FIG. 1, this rechargeable compact fluorescent floodlight also provide a mean of flashlight and is portable in its nature. It is very easy to use when used to search certain targets or when used to provide multi-angle lighting. The present invention is especially helpful to high-risk workers such as policemen, firemen or soldiers.

Said invention, rechargeable compact fluorescent floodlight has adjustable stands (12) at its bottom. It allows user to apply said flood light without holding it by hand and yet needs sufficient lighting by putting said floodlight on a supporting surface such as a table or ground.

This rechargeable compact fluorescent flood light is an important source of lighting mean employed in marine, army, public security, firefighters, emergency treatments, disciplined troops, architecture and civil vessels, as well as for emergency treatment in daily life.

What is claimed is:

1. A rechargeable compact fluorescent floodlight comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it; and
having a supporting means and such supporting mean can provide an adjustable mean with a tight or loose positions so as to controlling such supporting legs in a locked position or in a rotating position to reach the best lighting range and lighting angles; and
having two supporting legs can move relatively and interactively between position one and position two allowing tightly affixed at any position to provide an adjustable lighting angle, said supporting legs provide a support on plane surface for to provide a distance lighting mean with any angle over 90°, and
said supporting legs can also provide rotating positions through said adjustable hinge to any position within 270 degrees circular arc. They provide support for said housing in a horizontal position to get the best lighting angle, and having a handle attached to said housing providing mean of carrying.

2. A rechargeable compact fluorescent floodlight as recited in claim 1, wherein, said rechargeable compact fluorescent floodlight is further comprises:
at least one light bulb,
at least one arc shaped reflector,
at least one set of main switch,
at least one power receptacle for external electricity,
at least one transformer, and
at least one set of circuitry and power supply.

3. A rechargeable compact fluorescent floodlight as recited in claim 1, wherein supporting legs can provide an adjustable mean with a tight or loose positions so as to controlling such supporting legs in a locked position or in a rotating position to reach the best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said legs provide supports for said housing.

4. A rechargeable compact fluorescent floodlight as recited in claim 1, wherein said rechargeable compact fluorescent floodlight is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

5. A rechargeable compact fluorescent floodlight as recited in claim 1, wherein said rechargeable compact fluorescent floodlight comprises a lighting source, has an energy saving florescent light bulb, which is located on a light base. Electricity is provided by a power source within said housing. Electricity current goes through power cord to the insides of electrical circuitry of said housing and transformer, while connects power receptacle, on/off switch, and links up with energy saving florescent bulb.

6. A rechargeable compact fluorescent floodlight as recited in claim 1, wherein said rechargeable compact fluorescent floodlight can draw electricity either from AC power outlet provided from public utility or from the chargeable battery directly.

7. A rechargeable compact fluorescent floodlight as recited in claim 1, wherein said rechargeable compact fluorescent floodlight further comprises:
a handle in a rectangular shape is longitudinally attached to said housing. A front and rear of the handle are equipped with stripes so as to provide a mean of carrying.

8. A rechargeable compact fluorescent floodlight as recited in claim 1, wherein said rechargeable compact fluorescent floodlight further comprises:
a battery cover is located at rear portion of said housing. Metal screws tightly locked a battery cover to the rear bump of said housing. A seal packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.

9. A rechargeable compact fluorescent floodlight as recited in claim 2, wherein supporting legs can provide an adjustable mean with a tight or loose positions so as to controlling such supporting legs in a locked position or in a rotating position to reach the best lighting range and lighting angles through said attached hinge to any position within 270 degrees circular ark. Said supporting legs can move relatively and interactively between position one and position two allowing tightly affixed at any position to provide an adjustable lighting angle, said supporting legs provide a support on plane surface for to provide a distance lighting mean with any angle over 90°, Said legs provide supports for said housing.

10. A rechargeable compact fluorescent floodlight as recited in claim 2, wherein said rechargeable compact fluorescent floodlight is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

11. A rechargeable compact fluorescent floodlight as recited in claim 2, wherein said rechargeable compact fluorescent floodlight comprises a lighting source, has an energy saving florescent light bulb, which is located on a light base. Electricity is provided by a power source within said housing. Electricity current goes through power cord to the insides of electrical circuitry of said housing and transformer, while connects power receptacle, on/off switch, and links up with energy saving florescent bulb.

12. A rechargeable compact fluorescent floodlight as recited in claim 2, wherein said rechargeable compact fluorescent floodlight can draw electricity either from AC power outlet provided from public utility or from the chargeable battery directly.

13. A rechargeable compact fluorescent floodlight as recited in claim 1, wherein said rechargeable compact fluorescent floodlight further comprises:
a handle in a rectangular shape is longitudinally attached to said housing. A front and rear of the handle are equipped with stripes so as to provide a mean of carrying.

14. A rechargeable compact fluorescent floodlight as recited in claim 1, wherein said rechargeable compact fluorescent floodlight further comprises:
a battery cover is located at rear portion of said housing. Metal screws tightly locked a battery cover to the rear bump of said housing. A seal-packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.
